(19) United States
(12) Patent Application Publication
(10) Pub. No.: US 2026/0200043 A1
(43) Pub. Date: Jul. 16, 2026

(54) FIXTURE CONNECTOR AND FIXTURE DEVICE THEREOF

(71) Applicant: EHOMA INDUSTRIAL CORPORATION, TAICHUNG CITY (TW)

(72) Inventors: JYH-YUH CHANG, TAICHUNG CITY (TW); KAI-WEI HOU, TAICHUNG CITY (TW)

(21) Appl. No.: 19/016,303

(22) Filed: Jan. 10, 2025

(51) Int. Cl. B25B 5/16; B25B 5/02; B25B 5/10

(52) U.S. Cl. CPC B25B 5/166; B25B 5/02; B25B 5/102

(57) ABSTRACT

A fixture connector for connection between a fixture body and an extension shaft includes a first casing, a second casing, and two lock members. The first casing has a first end and a second end spaced apart along a longitudinal axis, with an open housing space formed therebetween. The housing space has two lock parts disposed in adjacent to the first end and the second end, respectively. The second casing covers the first casing and shields the housing space. The lock members rotationally pass through the first casing and the second casing along a transverse axis to be fastened to the two lock parts, respectively. Thus, the present disclosure is efficiently installed between the fixture body and the extension shaft, increasing the span of a fixture device to clamp a thicker object.

### BACKGROUND OF THE DISCLOSURE

### 1. Field of the Disclosure

The present disclosure relates to connecting devices, and more particularly, to a fixture connector of fixture device for extending the distance between two clamp parts of the fixture device.

### 2. Description of the Related Art

Referring to U.S. 11,642,760B2, a woodworking fixture connector is disclosed, whose two ends are provided with a clamp member, respectively, to form a set of woodworking fixture. The connector is configured to extend the distance between the two clamp members, such that the woodworking fixture is applicable to thicker workpieces.

The aforementioned connector mainly comprises a housing, a button, a through tube, a buckle, and a spring. The through tube, the buckle, and the spring are all disposed within the housing. The buckle is U-shaped and upwardly oriented to accommodate the through tube. The spring is arranged below the buckle between the buckle and the housing. The through tube is a flat tube with rod-receiving openings at both ends thereof. Each rod-receiving opening forms an inward pin guidance groove. The buckle has hooks at both ends thereof, and each hook has an upwardly opened groove arranged below the button. The hook swings or is restored to the original position in response to operations of the button. When a shaft body of the clamp member is inserted into the through tube, the groove and the pin guidance groove cooperate to be engaged with a positioning pin of the shaft body, so as to achieve the fixation effect. To release the fixation, the button is pressed to disengage the through tube and the buckle from the engagement status of the positioning pin, allowing the shaft body to be withdrawn from the housing.

However, the internal structure of the housing of the aforementioned patent is relatively complex. Also, if the spring experiences fatigue during use, the buckling force of the buckle on the positioning pin of the shaft body may decrease, increasing the risk of the shaft body detaching from the connector. Therefore, an improvement is desirable.

### SUMMARY OF THE DISCLOSURE

To improve the issues above, the present disclosure provides a fixture connector. With two casings combined and connected between the fixture body and the extension shaft, and with two lock members fastening and fixing the two casings, the present disclosure achieves an efficient assembly and positioning effect, realizing the structural simplicity and fastening stability. Moreover, the connector effectively maintains the certain clamping force of the fixture.

For achieving the aforementioned objectives, the present disclosure provides a fixture connector for connection of a fixture device, the fixture connector comprising:
a first casing having a first end and a second end spaced with each other and disposed along a direction of a longitudinal axis, with an open housing space formed between the first end and the second end, the housing space having two lock parts disposed in adjacent to the first end and the second end, respectively, the two lock parts disposed along a direction of a transverse axis perpendicular to the longitudinal axis;
a second casing covering the first casing and masking the housing space; and
two lock members rotationally passing through the first casing and the second casing along the direction of the transverse axis to be fastened to the two lock parts, respectively.

In another embodiment, the present disclosure provides a fixture device comprising:
a fixture connector having a first casing, a second casing, and two lock members, the first casing having a first end and a second end spaced with each other and disposed along a direction of a longitudinal axis on one side thereof, with a housing space formed between the first end and the second end, the housing space having two lock parts disposed in adjacent to the first end and the second end, respectively, the two lock parts disposed along a direction of a transverse axis perpendicular to the longitudinal axis;
a fixture body having a shaft part and a first clamp part, the shaft part having a first lock hole, the shaft part disposed in the housing space, such that the first lock hole is connected with one of the lock parts;
an extension shaft having a second lock hole on one end thereof, the extension shaft disposed in the housing space, such that the second lock hole is connected with the other one of the lock parts;
a slide member having one end thereof slidably disposed on the extension shaft; and
a clamp member disposed on another end of the slide member and having a second clamp part; wherein
the second casing covers the first casing and shields the housing space; the two lock members rotationally pass through the first casing and the second casing along the direction of the transverse axis to be fastened to the two lock parts, respectively, whereby the fixture connector is connected between the fixture body and the extension shaft.

With such configuration, the first casing and the second casing are combined and connected between the fixture body and the extension shaft, with the two lock members fastening and fixing the first casing and the second casing, achieving an effective positioning effect and realizing the structural simplicity and fastening stability. The extension shaft is connected with the fixture body through the fixture connector, so as to extend the distance between the first clamp part and the second clamp part, enlarging the span of the fixture device, thereby meeting the need of clamping an object having a greater thickness.

### BRIEF DESCRIPTION OF THE DRAWINGS

FIG. 1 is a perspective view of the fixture connector in accordance with an embodiment of the present disclosure.

FIG. 2 is an exploded view of the fixture connector in accordance with an embodiment of the present disclosure.

FIG. 3 is a schematic view of the operation status of the fixture connector in accordance with an embodiment of the present disclosure, illustrating the fixture connector connected between the fixture body and the extension shaft.

FIG. 4 is another schematic view of the operation status of the fixture connector in accordance with an embodiment of the present disclosure, illustrating the fixture connector fastening and fixing the fixture body and the extension shaft.

FIG. 5 is a cross-sectional view taken along line 5-5 in FIG. 4.

FIG. 6 is a cross-sectional view taken along line 6-6 in FIG. 4.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion. Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

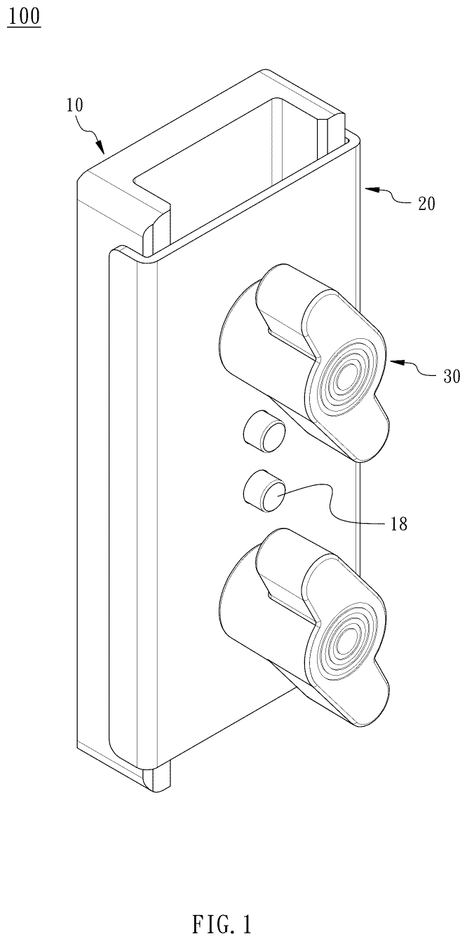

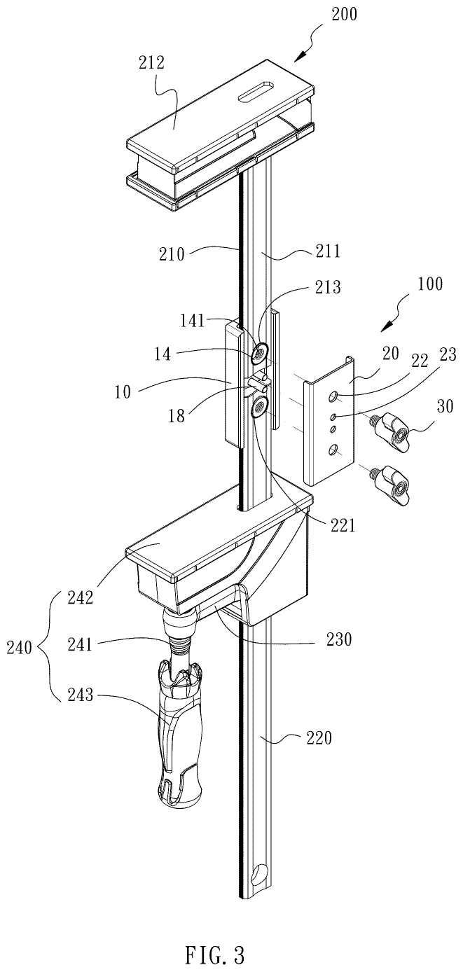

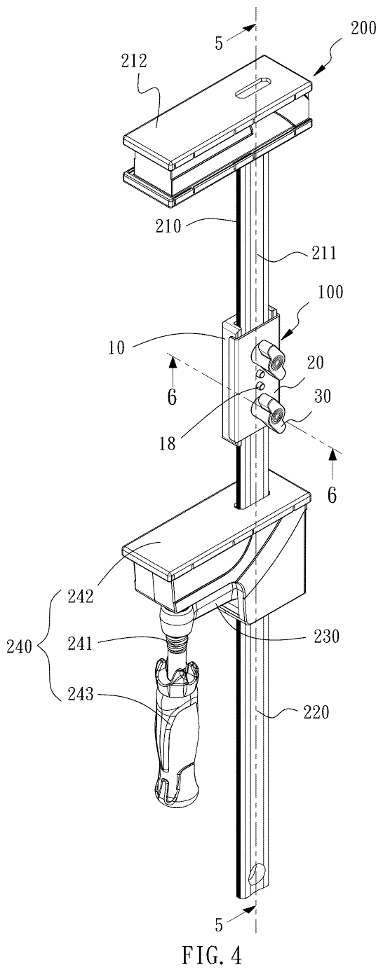

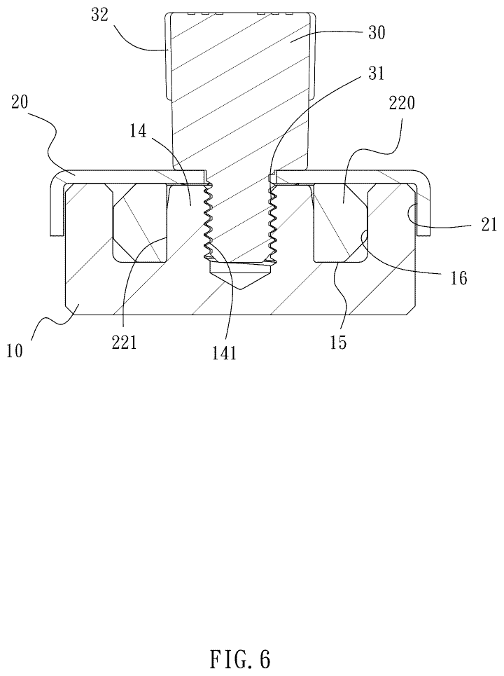

Referring to FIG. 1 to FIG. 6, the present disclosure provides a fixture connector 100 and a fixture device 200 thereof. As shown by FIG. 3 and FIG. 4, the fixture device 200 comprises a fixture body 210, an extension shaft 220, a slide member 230 disposed on the extension shaft 220, and a clamp member 240 disposed on the slide member 230. The fixture connector 100 is applied for connection of the fixture device 200, so as to be used for clamping an object having a greater thickness. The fixture connector 100 comprises a first casing 10, a second casing 20, and two lock members 30.

The first casing 10 is formed in an elongate shape having a U-shaped sectional face. The first casing 10 has a first end 11 and a second end 12 spaced with each other and disposed along a direction of a longitudinal axis X, with an open housing space 13 formed between the first end 11 and the second end 12. The housing space 13 has two lock parts 14 disposed in adjacent to the first end 11 and the second end 12, respectively, and the two lock parts 14 are disposed along a direction of a transverse axis Y perpendicular to the longitudinal axis X.

In the embodiment, the first casing 10 has an inner lateral face 15 and a corresponding open face 16, with a side wall 17 connected with two sides of the inner lateral face 15, respectively, such that the inner lateral face 15 and the two side walls 17 form the housing space 13. The two lock parts 14 protrude from the inner lateral face 15 and extend toward the open face 16. In addition, each of the two lock parts 14 has a thread bore 141.

The second casing 20 is allowed to cover the first casing 10 and shield the housing space 13. The second casing 20 is formed in a shape similar to the shape of the first casing 10. The second casing 20 has a U-shaped sectional face. The second casing 20 has two lateral walls 21 spaced with each other. The distance between the two lateral walls 21 is greater than the distance between the two side walls 17 of the first casing 10, such that the second casing 20 is allowed to cover the outer side of the first casing 10. In addition, the second casing 20 has two through holes 22.

The lock members 30 rotationally pass through the first casing 10 and the second casing 20 to be fastened to the two lock parts 14, so as to combine the first casing 10 and the second casing 20. In the embodiment, each lock member 30 comprises a thread part 31 and a knob part 32 away from the thread part 31. The user manually and rotationally operates the knob part 32, so that the thread part 31 passes through the through hole 22 to be screwed to the thread bore 141 of the corresponding lock part 14, whereby the first casing 10 and the second casing 20 are combined and fixed.

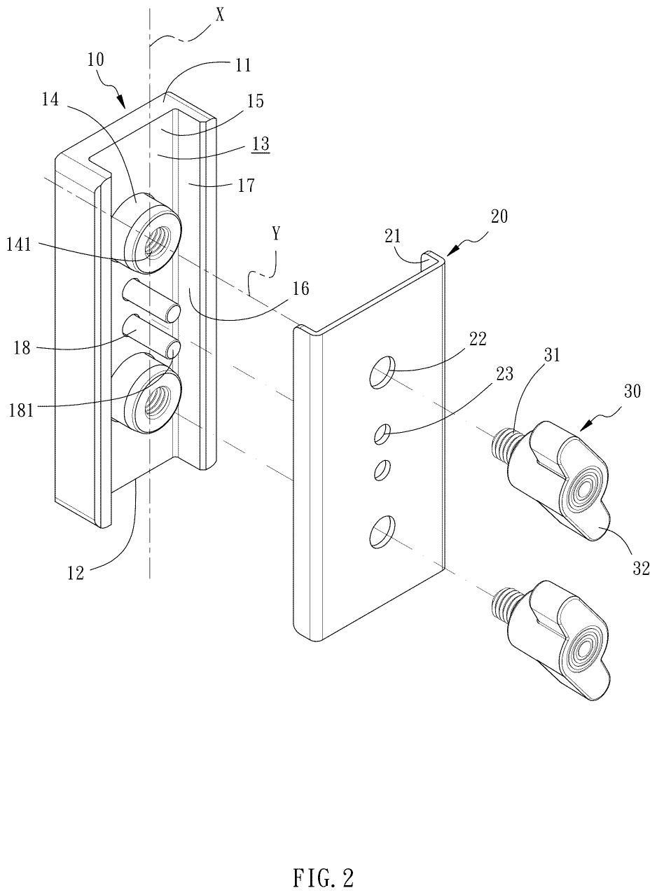

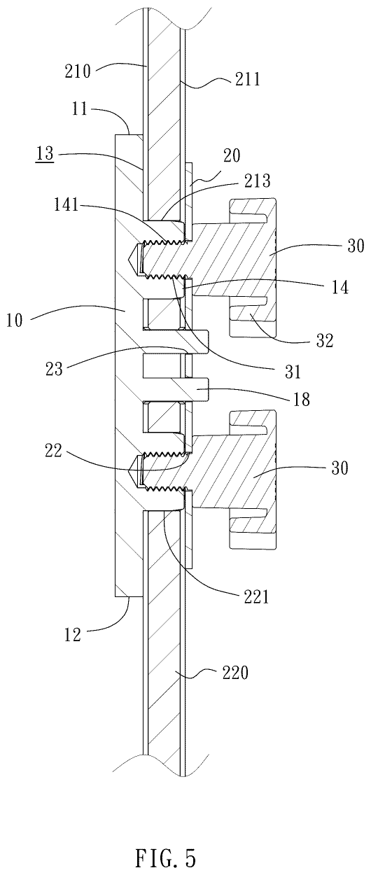

In the embodiment, a stop part 18 is disposed between the two lock parts 14. The stop part 18 comprises two pillars 181 extend from the inner lateral face 15 toward the open face 16. In other embodiments, the two pillars 181 are disposed in a parallel arrangement, and each pillar 181 is also arranged in parallel to each lock part 14 (as shown in FIG. 5). Also, two positioning bores 23 are disposed between the two through holes 22 of the second casing 20, such that the positioning bores 23 are combined with the corresponding pillars 181 when the second casing 20 covers the first casing 10. Referring to FIG. 1 and FIG. 2, when combined, each pillar 181 is exposed from the corresponding positioning hole 23, so as to provide a primary positioning effect to the first casing 10 and the second casing 20, allowing the lock members 30 to subsequently fasten and fix the first casing 10 and the second casing 20.

The fixture body 210 is formed in an L shape. The fixture body 210 comprises a shaft part 211 and a first clamp part 212. The shaft part 211 has a first lock hole 213 arranged away from the first clamp part 212. The shaft part 211 is disposed in the housing space 13, with the first lock hole 213 combined with one of the lock parts 14, and the shaft part 211 abuts against one side of the pillar 181 of the stop part 18.

The extension shaft 220 has a second lock hole 221 on one end thereof. The extension shaft 220 is disposed in the housing space 13, with the second lock hole 221 combined with the other lock part 14, and the extension shaft 220 abuts against one side of the other pillar 181 of the stop part 18. Accordingly, the fixture body 210 and the extension shaft 220 are blocked and positionally limited by the stop part 18 and the two side walls 17, providing a positioning range of the fixture body 210 and the extension shaft 220, also preventing rotation and twisting of components. Based on the fact that the fixture connector 100 is combined between the fixture body 210 and the extension shaft 220 to form a rigid body, twisting of components during clamping operation is prevented, avoiding the reduction of clamping force.

The slide member 230 has one end slidably disposed on the extension shaft 220.

The clamp member 240 is disposed on the other end of the slide member 230. The clamp member 240 comprises a thread rod 241 screwed to the slide member 230. The thread rod 241 has a second clamp part 242 on one end thereof, and a handle 243 on another end thereof. The handle 243 is configured to control the thread rod 241 to reciprocate with respect to the slide member 230, so as to adjust the distance between the first clamp part 212 and the second clamp part 242, thereby clamping an object.

Referring to FIG. 2 to FIG. 4, during use of the present disclosure, the shaft part 211 of the fixture body 210 is placed at one end of the housing space 13, with the first lock hole 213 mounted around one of the lock parts 14. Then, the extension shaft 220 is placed at the other end of the housing space 13, with the second lock hole 221 mounted around the other lock part 14. Next, the two lock members 30 pass through the through holes 22 of the second casing 20 to be fastened to the thread bores 141 of the lock parts 14 of the first casing 10, whereby the fixture connector 100 is connected between the fixture body 210 and the extension shaft 220.

With the foregoing configuration, the distance between the first clamp part 212 and the second clamp part 242 is extended, so as to clamp an object having greater thickness, fulfilling operational demands.

The fixture connector 100 of the present disclosure is structurally simple and stably fastened, so as to be efficiently installed between the fixture body 210 and the extension shaft 220, facilitating the convenience of use.

Although particular embodiments of the disclosure have been described in detail for purposes of illustration, various modifications and enhancements may be made without departing from the spirit and scope of the disclosure. Accordingly, the disclosure is not to be limited except as by the appended claims.

What is claimed is:

1. A fixture connector for connection of a fixture device, the fixture connector comprising:
a first casing having a first end and a second end spaced with each other and disposed along a direction of a longitudinal axis, with an open housing space formed between the first end and the second end, the housing space having two lock parts disposed in adjacent to the first end and the second end, respectively, the two lock parts disposed along a direction of a transverse axis perpendicular to the longitudinal axis;
a second casing covering the first casing and masking the housing space; and
two lock members rotationally passing through the first casing and the second casing along the direction of the transverse axis to be fastened to the two lock parts, respectively.

2. The fixture connector of claim 1, wherein the first casing has an inner lateral face and a corresponding open face, with a side wall connected with two sides of the inner lateral face, respectively, such that the inner lateral face and the two side walls form the housing space; the two lock parts protrude from the inner lateral face and extend toward the open face.

3. The fixture connector of claim 2, wherein each of the two lock parts has a thread bore; the second casing has two through holes; each of the two lock members comprises a thread part and a knob part away from the thread part; each of the thread parts passes through the corresponding through hole to be screwed to the corresponding thread bore.

4. The fixture connector of claim 2, wherein the first casing and the second casing have a U-shaped sectional face, respectively; the second casing has two lateral walls spaced with each other; a distance between the two lateral walls is greater than a distance between the two side walls, such that the second casing covers an outer side of the first casing.

5. The fixture connector of claim 2, wherein a stop part is disposed between the two lock parts; when the fixture device comprises a fixture body and an extension shaft that are placed in the housing space and connected with the two lock parts, respectively, the fixture body and the extension shaft are positionally limited by the stop part and the two side walls.

6. The fixture connector of claim 5, wherein the stop part comprises two pillars extending from the inner lateral face toward the open face, and the second casing comprises two positioning bores, such that the two positioning bores are combined with the two pillars.

7. A fixture device, comprising:
a fixture connector having a first casing, a second casing, and two lock members, the first casing having a first end and a second end spaced with each other and disposed along a direction of a longitudinal axis on one side thereof, with a housing space formed between the first end and the second end, the housing space having two lock parts disposed in adjacent to the first end and the second end, respectively, the two lock parts disposed along a direction of a transverse axis perpendicular to the longitudinal axis;
a fixture body having a shaft part and a first clamp part, the shaft part having a first lock hole, the shaft part disposed in the housing space, such that the first lock hole is connected with one of the lock parts;
an extension shaft having a second lock hole on one end thereof, the extension shaft disposed in the housing space, such that the second lock hole is connected with the other one of the lock parts;
a slide member having one end thereof slidably disposed on the extension shaft; and
a clamp member disposed on another end of the slide member and having a second clamp part; wherein
the second casing covers the first casing and shields the housing space; the two lock members rotationally pass through the first casing and the second casing along the direction of the transverse axis to be fastened to the two lock parts, respectively, whereby the fixture connector is connected between the fixture body and the extension shaft.

8. The fixture device of claim 7, wherein the first casing has an inner lateral face and a corresponding open face, with a side wall connected with two sides of the inner lateral face, respectively, such that the inner lateral face and the two side walls form the housing space; the two lock parts protrude from the inner lateral face and extend toward the open face.

9. The fixture device of claim 8, wherein each of the two lock parts has a thread bore; the second casing has two through holes; each of the two lock members comprises a thread part and a knob part away from the thread part; each of the thread parts passes through the corresponding through hole to be screwed to the corresponding thread bore.

10. The fixture device of claim 8, wherein the first casing and the second casing have a U-shaped sectional face, respectively; the second casing has two lateral walls spaced with each other; a distance between the two lateral walls is greater than a distance between the two side walls, such that the second casing covers an outer side of the first casing.

11. The fixture device of claim 8, wherein a stop part is disposed between the two lock parts; the shaft part abuts against one side of the stop part, and the extension shaft abuts against another side of the stop part, such that the fixture body and the extension shaft are positionally limited by the stop part and the two side walls.

12. The fixture device of claim 11, wherein the stop part comprises two pillars extending from the inner lateral face toward the open face, and the second casing comprises two positioning bores, such that the two positioning bores are combined with the two pillars; the fixture body is formed in an L shape; the clamp member comprises a thread rod screwed to the slide member; the thread rod comprises a second clamp part on one end thereof and a handle on another end thereof.
